(19) United States
(12) Patent Application Publication
(10) Pub. No.: US 2023/0011082 A1
(43) Pub. Date: Jan. 12, 2023

(54) Combine Orientation Tracking Techniques of Different Data Rates to Generate Inputs to a Computing System

(71) Applicant: Finch Technologies Ltd., Fish Bay (VG)

(72) Inventors: Viktor Vladimirovich Erivantcev, Ufa (RU); Rustam Rafikovich Kulchurin, Ufa (RU); Ratmir Rasilevich Gubaidullin, Ufa (RU); Alexey Andreevich Gusev, Ufa (RU); Roman Tagirovich Karimov, Ufa (RU); Guzel Kausarevna Khurmatullina, Ufa (RU)

(21) Appl. No.: 17/369,239

(22) Filed: Jul. 7, 2021

(51) Int. Cl. H04W 84/18; G06N 3/08; G06K 9/62

(52) U.S. Cl. CPC H04W 84/18; G06N 3/08; G06K 9/623

(57) ABSTRACT

A system to combine inertial-based measurements and optical-based measurements via a Kalman-type filter. For example, a sensor module uses an inertial measurement unit to generate first positions and first orientations of the sensor module at a first time interval during a first period of time containing multiple of the first time interval. At least one camera is used to capture images of the sensor module at a second time interval, larger than the first time interval, during the first period of time containing multiple of the second interval. Second positions and second orientations of the sensor module during the first period of time are computed from the images. The filter receives the first positions, the first orientations, the second positions, and the second orientations to generate estimates of position and orientation of the sensor module at a time interval no smaller than the first time interval.

### RELATED APPLICATIONS

The present application relates to U.S. patent application Ser. No. 16/433,619, filed Jun. 6, 2019, issued as U.S. Pat. No. 11,009,964 on May 18, 2021, and entitled “Length Calibration for Computer Models of Users to Generate Inputs for Computer Systems,” U.S. patent application Ser. No. 16/375,108, filed Apr. 4, 2019, published as U.S. Pat. App. Pub. No. 2020/0319721, and entitled “Kinematic Chain Motion Predictions using Results from Multiple Approaches Combined via an Artificial Neural Network,” U.S. patent application Ser. No. 16/044,984, filed Jul. 25, 2018, issued as U.S. Pat. No. 11,009,941, and entitled “Calibration of Measurement Units in Alignment with a Skeleton Model to Control a Computer System,” U.S. patent application Ser. No. 15/996,389, filed Jun. 1, 2018, issued as U.S. Pat. No. 10,416,755, and entitled “Motion Predictions of Overlapping Kinematic Chains of a Skeleton Model used to Control a Computer System,” U.S. patent application Ser. No. 15/973,137, filed May 7, 2018, published as U.S. Pat. App. Pub. No. 2019/0339766, and entitled “Tracking User Movements to Control a Skeleton Model in a Computer System,” U.S. patent application Ser. No. 15/868,745, filed Jan. 11, 2018, issued as U.S. Pat. No. 11,016,116, and entitled “Correction of Accumulated Errors in Inertial Measurement Units Attached to a User,” U.S. patent application Ser. No. 15/864,860, filed Jan. 8, 2018, issued as U.S. Pat. No. 10,509,464, and entitled “Tracking Torso Leaning to Generate Inputs for Computer Systems,” U.S. patent application Ser. No. 15/847,669, filed Dec. 19, 2017, issued as U.S. Pat. No. 10,521,011, and entitled “Calibration of Inertial Measurement Units Attached to Arms of a User and to a Head Mounted Device,” U.S. patent application Ser. No. 15/817,646, filed Nov. 20, 2017, issued as U.S. Pat. No. 10,705,113, and entitled “Calibration of Inertial Measurement Units Attached to Arms of a User to Generate Inputs for Computer Systems,” U.S. patent application Ser. No. 15/813,813, filed Nov. 15, 2017, issued as U.S. Pat. No. 10,540,006, and entitled “Tracking Torso Orientation to Generate Inputs for Computer Systems,” U.S. patent application Ser. No. 15/792,255, filed Oct. 24, 2017, issued as U.S. Pat. No. 10,534,431, and entitled “Tracking Finger Movements to Generate Inputs for Computer Systems,” U.S. patent application Ser. No. 15/787,555, filed Oct. 18, 2017, issued as U.S. Pat. No. 10,379,613, and entitled “Tracking Arm Movements to Generate Inputs for Computer Systems,” and U.S. patent application Ser. No. 15/492,915, filed Apr. 20, 2017, issued as U.S. Pat. No. 10,509,469, and entitled “Devices for Controlling Computers based on Motions and Positions of Hands.” The entire disclosures of the above-referenced related applications are hereby incorporated herein by reference.

### TECHNICAL FIELD

At least a portion of the present disclosure relates to computer input devices in general and more particularly but not limited to input devices for virtual reality and/or augmented/mixed reality applications implemented using computing devices, such as mobile phones, smart watches, similar mobile devices, and/or other devices.

### BACKGROUND

U.S. Pat. App. Pub. No. 2014/0028547 discloses a user control device having a combined inertial sensor to detect the movements of the device for pointing and selecting within a real or virtual three-dimensional space.

U.S. Pat. App. Pub. No. 2015/0277559 discloses a finger-ring-mounted touchscreen having a wireless transceiver that wirelessly transmits commands generated from events on the touchscreen.

U.S. Pat. App. Pub. No. 2015/0358543 discloses a motion capture device that has a plurality of inertial measurement units to measure the motion parameters of fingers and a palm of a user.

U.S. Pat. App. Pub. No. 2007/0050597 discloses a game controller having an acceleration sensor and a gyro sensor. U.S. Pat. No. D772,986 discloses the ornamental design for a wireless game controller.

Chinese Pat. App. Pub. No. 103226398 discloses data gloves that use micro-inertial sensor network technologies, where each micro-inertial sensor is an attitude and heading reference system, having a tri-axial micro-electromechanical system (MEMS) micro-gyroscope, a tri-axial micro-acceleration sensor and a tri-axial geomagnetic sensor which are packaged in a circuit board. U.S. Pat. App. Pub. No. 2014/0313022 and U.S. Pat. App. Pub. No. 2012/0025945 disclose other data gloves.

U.S. Pat. App. Pub. No. 2016/0085310 discloses techniques to track hand or body pose from image data in which a best candidate pose from a pool of candidate poses is selected as the current tracked pose.

U.S. Pat. App. Pub. No. 2017/0344829 discloses an action detection scheme using a recurrent neural network (RNN) where joint locations are applied to the recurrent neural network (RNN) to determine an action label representing the action of an entity depicted in a frame of a video.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 illustrates a system to track user movements according to one embodiment.

FIG. 2 illustrates a system to control computer operations according to one embodiment.

FIG. 3 illustrates a skeleton model that can be controlled by tracking user movements according to one embodiment.

FIG. 4 shows a technique to combine measurements from an optical-based tracking system and an inertial-based tracking system to determine the positions and orientations of parts of a user according to one embodiment.

FIG. 5 shows a method to generate real-time estimates of positions and orientations of a sensor module according to one embodiment.

### DETAILED DESCRIPTION

The following description and drawings are illustrative and are not to be construed as limiting. Numerous specific details are described to provide a thorough understanding. However, in certain instances, well known or conventional details are not described to avoid obscuring the description. References to one or an embodiment in the present disclosure are not necessarily references to the same embodiment; and, such references mean at least one.

At least some embodiments disclosed herein allow the efficient and accurate tracking of various parts or portions of a user, such as hands and arms, to generate inputs to control a computing device. The tracking is performed using both inputs from an inertial-based tracking system and an optical-based tracking system. The inputs from the different tracking systems can be combined with a filter, such as a Kalman Filter, or a modified Kalman Filter.

The inertial-based tracking system is typically configured with micro-electromechanical system (MEMS) inertial measurement units (IMUs) to measure the rotation and/or acceleration of body parts of the user and calculate the positions and orientations of the body parts through integration of measurements from the IMUs over time. The inertial-based tracking system can generate measurements at a fast rate (e.g., 1000 times a second). Thus, the positions and orientations determined from the inertial-based tracking system can better reflect the real time positions and orientations of the user. Further, the calculation performed by the inertial-based tracking system is less computationally intensive and thus energy efficient. However, the integration calculation can accumulate error to cause drift in measurements of positions and orientations.

The optical-based tracking system is typically configured with one or more cameras to capture images of body parts of the user and determine the positions and orientations of body parts as shown in the images. The optical-based tracking system can measure positions and orientations accurately without accumulating drifting errors over time. However, when the body parts of the user are moved outside of the field of view of the cameras, the optical-based tracking system cannot determine the positions and orientations of the body parts. The calculation performed by the optical-based tracking system can be computationally intensive. Thus, when the body parts are in the view of the cameras, the optical-based tracking system generates position and orientation measurements at a rate (e.g., 30 to 60 times a second) that is much slower than the inertial-based tracking system.

In at least some embodiments, a Kalman Filter or a modified Kalman Filter is used to combine the measurements from the inertial-based tracking system and, when available, the measurements from the optical-based tracking system. A Kalman-type filter uses a set of filter parameters to compute new estimates of state parameters based on previous estimates of the state parameters and new measurements of the state parameters. The filter parameters provide weights that are less than one for the previous estimates such that over a number of iterations, the errors in the initial estimates and past estimates become negligible.

In some implementations, the positions and orientations determined by the optical-based tracking system, when available, can be used to as an initial estimation of the measurements of the positions and orientations of the body parts of the user. Alternatively, the initial estimation can be based on the positions and orientations of the body parts of the user, as assumed or inferred for the inertial-based measurement system, when the user is in a known calibration pose.

Subsequently, when available, measurements of positions and orientations, from the inertial-based tracking system and/or the optical-based tracking system, can be used to update the estimates via the Kalman-type filter. The updates reduce the influences of the errors in the initial estimates and past estimates through iterations and the weights applied via the filter parameters. Thus, drifting errors in the measurements of inertial-based tracking system can be reduced via the inputs from the optical-based tracking system; and when the inputs from the optical-based tracking system become unavailable, e.g., due to the slow rate of measurements from the optical-based tracking system and/or the body parts moving outside of the field of view of the cameras, the inputs from the inertial-based tracking system can provide substantially real-time estimates of the positions and orientations of the body parts of the user. Further, after the estimates are improved via the inputs from the optical-based tracking system, the improved estimates can be used to calibrate the inertial-based tracking system and thus remove the accumulated drifts in the inertial-based tracking system. Alternatively, the measurements from the optical-based tracking system can be used directly to calibrate the inertial-based tracking system, after accounting for the measurement delay of the optical-based tracking system.

Thus, when no measurement is available from the optical-based tracking system due to the slow processing pace of the optical-based tracking system and/or a part of the user having moved out of the field of view of the camera, the Kalman-type filter can continue using the inputs from the inertial-based tracking system to generate real time estimates of the positions and orientations of the body parts based on measurements of IMUs attached to the body parts. When measurements from the optical-based tracking system become available, the quality of estimates of the Kalman-type filter improves to reduce the errors from the inertial-based tracking system.

The position and orientation of a part of the user, such as a hand, a forearm, an upper arm, the torso, or the head of the user, can be used to control a skeleton model in a computer system. The state and movement of the skeleton model can be used to generate inputs in a virtual reality (VR), mixed reality (MR), augmented reality (AR), or extended reality (XR) application. For example, an avatar can be presented based on the state and movement of the parts of the user.

A skeleton model can include a kinematic chain that is an assembly of rigid parts connected by joints. A skeleton model of a user, or a portion of the user, can be constructed as a set of rigid parts connected by joints in a way corresponding to the bones of the user, or groups of bones, that can be considered as rigid parts.

For example, the head, the torso, the left and right upper arms, the left and right forearms, the palms, phalange bones of fingers, metacarpal bones of thumbs, upper legs, lower legs, and feet can be considered as rigid parts that are connected via various joints, such as the neck, shoulders, elbows, wrist, and finger joints.

In some instances, the movements of a kinematic chain representative of a portion of a user of a VR/MR/AR/XR application can have a pattern such that the orientations and movements of some of the parts on the kinematic chain can be used to predict or calculate the orientations of other parts. For example, based on the orientation of an upper arm and a hand, the forearm connecting the upper arm and the hand can be predicted or calculated, as discussed in U.S. Pat. No. 10,379,613. For example, based on the orientation of the palm of a hand and a phalange bone on the hand, the orientation of one or other phalange bones and/or a metacarpal bone can be predicted or calculated, as discussed in U.S. Pat. No. 10,534,431. For example, based on the orientation of the two upper arms and the head of the user, the orientation of the torso of the user can be predicted or calculated, as discussed in U.S. Pat. Nos. 10,540,006, and 10,509,464.

The position and/or orientation measurements generated using inertial measurement units can have drifts resulting from accumulated errors. Optionally, an initialization operation can be performed periodically to remove the drifts. For example, a user can be instructed to make a predetermined pose; and in response, the position and/or orientation measurements can be initialized in accordance with the pose, as discussed in U.S. Pat. No. 10,705,113. For example, an optical-based tracking system can be used to assist the initialization in relation with the pose, or on-the-fly, as discussed in U.S. Pat. Nos. 10,521,011 and 11,016,116.

In some implementations, a pattern of motion can be determined using a machine learning model using measurements from an optical tracking system; and the predictions from the model can be used to guide, correct, or improve the measurements made using an inertial-based tracking system, as discussed in U.S. Pat. App. Pub. No. 2019/0339766, U.S. Pat. Nos. 10,416,755, 11,009,941, and U.S. Pat. App. Pub. No. 2020/0319721.

The disclosures of the above discussed patent documents are hereby incorporated herein by reference.

A set of sensor modules having optical markers and IMUs can be used to facilitate the measuring operations of both the optical-based tracking system and the inertial-based tracking system. Some aspects of a sensor module can be found in U.S. patent application Ser. No. 15/492,915, filed Apr. 20, 2017, issued as U.S. Pat. No. 10,509,469, and entitled “Devices for Controlling Computers based on Motions and Positions of Hands.”

The entire disclosures of the above-referenced related applications are hereby incorporated herein by reference.

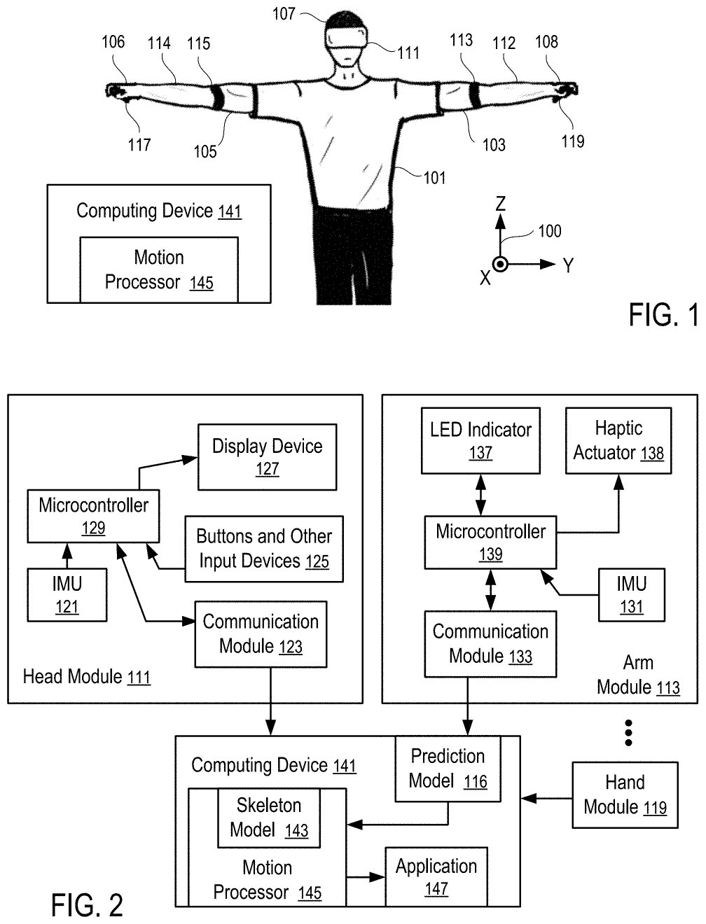

FIG. 1 illustrates a system to track user movements according to one embodiment.

FIG. 1 illustrates various parts of a user, such as the torso 101 of the user, the head 107 of the user, the upper arms 103 and 105 of the user, the forearms 112 and 114 of the user, and the hands 106 and 108 of the user. Each of such parts of the user can be modeled as a rigid part of a skeleton model of the user in a computing device; and the positions, orientations, and/or motions of the rigid parts connected via joints in the skeleton model in a VR/MR/AR/XR application can be controlled by tracking the corresponding positions, orientations, and/or motions of the parts of the user.

In FIG. 1, the hands 106 and 108 of the user can be considered rigid parts movable around the wrists of the user. In other applications, the palms and finger bones of the user can be further tracked to determine their movements, positions, and/or orientations relative to finger joints to determine hand gestures of the user made using relative positions among fingers of a hand and the palm of the hand.

In FIG. 1, the user wears several sensor models to track the orientations of parts of the user that are considered, recognized, or modeled as rigid in an application. The sensor modules can include a head module 111, arm modules 113 and 115, and/or hand modules 117 and 119. The sensor modules can measure the motion of the corresponding parts of the user, such as the head 107, the upper arms 103 and 105, and the hands 106 and 108 of the user. Since the orientations of the forearms 112 and 114 of the user can be predicted or calculated from the orientation of the upper arms 103 and 105, and the hands 106 and 108 of the user (e.g., as discussed in), the system as illustrated in FIG. 1 can track the positions and orientations of kinematic chains involving the forearms 112 and 114 without the user wearing separate/additional sensor modules on the forearms 112 and 114.

In general, the position and/or orientation of a part in a reference system 100 can be tracked using one of many systems known in the field. For example, an optical-based tracking system can use one or more cameras to capture images of a sensor module marked using optical markers and analyze the images to compute the position and/or orientation of the part. For example, an inertial-based tracking system can use a sensor module having an inertial measurement unit to determine its position and/or orientation and thus the position and/or orientation of the part of the user wearing the sensor module. Other systems may track the position of a part of the user based on signals transmitted from, or received at, a sensor module attached to the part. Such signals can be radio frequency signals, infrared signals, ultrasound signals, etc. The measurements from different tracking system can be combined via a Kalman-type filter as further discussed below.

In one embodiment, the modules 111, 113, 115, 117 and 119 can be used both in an optical-based tracking system and an inertial-based tracking system. For example, a module (e.g., 113, 115, 117 and 119) can have one or more LED indicators to function as optical markers; when the optical markers are in the field of view of one or more cameras in the head module 111, images captured by the cameras can be analyzed to determine the position and/or orientation of the module. Further, each of the modules (e.g., 111, 113, 115, 117 and 119) can have an inertial measurement unit to measure its acceleration and/or rotation and thus to determine its position and/or orientation. The system can dynamically combine the measurements from the optical-based tracking system and the inertial-based tracking system using a Kalman-type filter approach for improved accuracy and/or efficiency.

Once the positions and/or orientations of some parts of the user are determined using the combined measurements from the optical-based tracking system and an inertial-based tracking system, the positions and/or orientations of some parts of the user having omitted sensor modules can be predicted and/or computed using the techniques, discussed in above-referenced patent documents, based on patterns of motions of the user. Thus, user experiences and cost of the system can be improved.

In general, optical data generated using cameras in the optical-based tracking system can provide position and/or orientation measurements with better accuracy than the inertial-based tracking system, especially when the initial estimate of position and orientation has significant errors. Processing optical data is computationally intensive and time consuming. The data rate of input from the camera can limit the rate of position and/or orientation measurements from the optical-based tracking system. Further, the computation involved in processing the optical data can cause noticeable measurement delays between the time of the position and/or orientation of a part of a user and the time of the measurement of the position and/or orientation becoming available from the optical-based tracking system. For example, the optical-based tracking system can be used to generate position and/or orientation measurements at the rate of 30 to 60 times a second.

In contrast, an inertial-based tracking system can produce measurements at a much higher rate (e.g., 1000 times a second) based on measurements from accelerometers, gyroscopes, and/or magnetometers. However, tracking positions and/or orientations using the inertial measurement units can accumulate drift errors and can rely upon the accuracy of an initial estimation of position and orientation for the calibration of the inertial-based tracking system.

In one embodiment, an initial estimate of the position and orientation of a sensor module can be based on a measurement from the optical-based tracking system, or based on an inference or assumption of the sensor module being in the position or orientation when the sensor module is in a calibration state. The initial estimates can be used to calibrate or initialize the calculation of the position and orientation of the sensor module based on the measurements from the accelerometers, gyroscopes, and/or magnetometers. Before a subsequent measurement is available from the optical-based measurement system (or another system), the fast measurements of the inertial-based tracking system can be used to provide near real-time measurements of positions and orientations of the sensor module. For example, the position and orientation measurements calculated based on the input data from the accelerometers, gyroscopes, and/or magnetometers can be used as input to a Kalman-type filter to obtain improved real-time estimates of the position and orientations of the sensor module.

When the subsequent measurement is available from the optical-based tracking system (or another system), the subsequent measurement can be provided as improved inputs to the Kalman-type filter to reduce the errors in the initial and past estimates. A sequence of measurements from the optical-based measurement system (or another system) can be provided as input to the Kalman-type filter to reduce the errors in the initial estimates and subsequent accumulated drift errors from the inertial-based tracking system. Periodically, the computation of the inertial-based tracking system can be re-calibrated using the improved estimates from the Kalman-type filters and/or from the measurements of the optical-based tracking system (or another system). When the measurements from the optical-based measurement system is available, the drift that can be accumulated through the measurements of the inertial-based tracking system is limited by the time interval of the measurements of the optical-based measurement system. Since such a time interval is small (e.g., 30 to 60 intervals per second), the drift errors and initial estimation error are well controlled. When the sensor module is moved out of the field of view of the camera of the optical-based measurement system, the Kalman-type filter can continue generating real-time estimates using the inertial-based tracking system, with increasing drift errors over time until the sensor module is moved back into the field of view.

In FIG. 1, a computing device 141 is configured with a motion processor 145. The motion processor 145 combines the measurements from the optical-based tracking system and the measurements from the inertial-based tracking system using a Kalman-type of filter to generate improved measurements with reduced measurement delay, reduce drift errors, and/or a high rate of measurements.

For example, to make a measurement of the position and/or orientation of an arm module 113 or 115, or a hand module 117 or 119, the camera of the head module 111 can capture a pair of images representative of a stereoscopic view of the module being captured in the images. The images can be provided to the computing device 141 to determine the position and/or orientation of the module relative to the head 107, or stationary features of the surrounding observable in the images captured by the cameras, based on the optical markers of the sensor module captured in the images.

For example, to make a measurement of the position and/or orientation of the sensor module, the accelerometer, the gyroscope, and the magnetometer in the sensor module can provide measurement inputs. A prior position and/or orientation of the sensor module and the measurement from the accelerometer, the gyroscope, and the magnetometer can be combined with the lapsed time to determine the position and/or orientation of the sensor module at the time of the current measurement.

Since the calculation to provide the current measurement from the input data generated by the accelerometer, the gyroscope, and the magnetometer is not computationally intensive, the sensor module can perform the computation and provide the current measurement of the position and/or orientation to the computing device 141. Alternatively, the input data from the accelerometer, the gyroscope, and the magnetometer can be provided to the computing device 141 to determine the current measurement of the position and/or orientation as measured by the inertial measurement unit of the sensor module. For example, a time integration operation can be performed over the input measurements from the accelerometer, the gyroscope, and the magnetometer to determine the current inertial-based measurement of the position and/or orientation of the sensor module. For example, a simple double integration operation of the acceleration and angular velocity of the sensor module, as measured by its inertial measurement unit, can be used to calculate the current position and orientation of the sensor module. For improved accuracy and/or reduced drift errors, a higher order integration technique, such as a Runge-Kutta method, can be used. The Runge-Kutta method includes the use of a cubic-spline interpolation to rebuild the intermediate values between measurements and thus can provide integration results with improved accuracy.

The measurements from the optical-based tracking system and the inertial-based tracking system can be combined via a conventional Kalman Filter.

A conventional Kalman Filter can be applied to combine a previous position estimate with a difference between the previous position estimate and a current position measurement using a weight factor α to obtain a current position estimate. The difference represents a measured change to the position estimate; and the weight factor α represents how much the prior estimate is to be changed in view of the measured change and thus a filtered contribution from the measured change. Similarly, a previous speed estimate can be combined with a measured speed in the time period using a weight factor β to ordain a current speed estimate. The measured speed change can be calculated in the form of a difference between the previous position estimate and a current position measurement divided by the lapsed time between the position measurements. The weight factor β represents the weight provided by the filter to the measured speed.

For example, parameters of a one-dimensional movement along a line can be modeled using the following formulas.

xₜ=x+st

sₜ=s+at

where x and xₜ represent the position of an object before and after a time period t; s and sₜ represent the speed of the object before and after the time period t; and a represents the acceleration of the object at time t, assuming that the object has a constant acceleration within the time period t.

Based on these formulas, a conventional Kalman Filter can be constructed to update estimate of the position and speed of the object based on a new measurement of the position after a time period t.

xₜ=x+α(z−x)

sₜ=s+β(z−x)/t

where z is a new measurement of the position of the object after the time period t.

Such a conventional Kalman Filter can be used to combine the optical-based tracking results and the inertial-based track results that are produced at different rates. The filter parameters α and β can be selected and applied to update estimates of state parameters x and s in view of the new measurement z of the next state xₜ after a time period of t. After a series of updates following a number of time periods of measurements, the error in the initial estimates of the position and speed becomes negligible; and noises in measurements are suppressed.

Since the optical-based tracking system generally provides more accurate position measurements than the inertial-based track system, the filter parameters α and β used for the inputs from the optical-based tracking system can be selected to provide more weights than for the inputs from the inertial-based tracking system.

For example, when a position of a sensor module as determined by the optical-based tracking system is available, the position can be used as an initial, previous estimate (e.g., by using a value of a that is equal to or close to one). Subsequently, when a position of the sensor module as determined by the inertial-based tracking system is available, the position can be used as a current position measurement to obtain a current position estimate via the weight factor α (e.g., using a value of α that is smaller than one); and the current speed can be estimated using the weight factor β. The position and speed estimates can be updated multiple times using the position calculated using the inertial-based tracking system before a next position determined by the optical-based tracking system is available. When the next position calculated by the optical-based tracking system is available, it can be used as another current measurement to update the previous estimate. The update can be based on the prior estimate updated at the time of the prior measurement from the optical-based tracking system, or the immediate prior estimate updated according to the most recent measurement from the inertial-based tracking system, or another prior estimated updated between the time of the prior measurement from the optical-based tracking system and the most recent measurement from the inertial-based tracking system.

Since the optical-based tracking system is considered more accurate than the inertial-based tracking system, the weight factor α applied for combining the position measured by the optical-based tracking system can be larger than the weight factor α applied for combining the position measured by the inertial-based tracking system. When the weight factor α use for the optical-based tracking system is sufficiently large (e.g., close to one), the position measurement from the optical-based tracking system can effectively reinitialize the estimate based on the position measurement from the optical-based tracking system.

Optionally, the current speed estimate can be used as an initial condition for the measurement of the next position calculated by the IMU measurements by the sensor module.

In one embodiment, a modified Kalman-type filter is configured to combine measurements not only for positions but also for orientations. For example, the orientation of the sensor module can be expressed as a quaternion or an orientation vector. When an orientation measurement (e.g., in the form of a quaternion or an orientation vector) is updated, the previous orientation is rotated according to an angular velocity measured by the inertial measurement unit in the sensor module. Thus, the updated angular velocity is a non-linear function of the prior orientation.

In one embodiment, the following formulas are used to model the relations among the three-dimensional position p and orientation q in relation with biases and noises of accelerometer and gyroscope.

pₜ=p+vt+(R(aₘ−a_{b})+g)t²/2

vₜ=v+(R(aₘ−a_{b})+g)t

qₜ=q×{(wₘ−w_{b})t}

where pₜ, vₜ, and qₜ represent the position, velocity, and orientation of a sensor module after a time period t; p, v, and q represent the position, velocity and orientation before the time period t; g represents the gravity vector; R represents a rotation matrix to aligns the measurement directions of acceleration and gravity vector; aₘ represents accelerometer sensor noise as a constant or a known function of time (e.g., identified by manufacturer, or calculated using an empirical formula based on testing); wₘ represents is gyroscope noise as a constant or a known function of time (e.g., identified by manufacturer, or calculated using an empirical formula based on testing); a_{b} is accelerometer bias that typically changes over time; and w_{b} is gyroscope bias that typically changes over time.

Based on the above formulas, a modified Kalman-type filter can be constructed to update estimates of position p, velocity v, and orientation q, using filter parameters (e.g., α and β) and new measurements. In some implementations, the state parameters further include the biases a_{b} and w_{b}.

For example, when a new measurement of a state parameter (e. p and q) is obtained, the new estimate of the state parameter can be the sum of the old estimate of the state parameter and a change from the old estimate to the new measurement weighted by a filter parameter α. Further, the rate of the state parameter (e.g., v) can be computed based on the modeled relations; and the new estimate of the rate of the state parameter can be the sum of the old estimate of the rate and a computed rate weighted by a filter parameter β.

In some implementations, a modified Kalman-type filter can be configured to account for the different delivery delays in measurements from the optical-based tracking system and from the inertial-based tracking system. A filter implementation can include the time delay between the instance of a state parameter being measured by a tracking system and the instance of the value of the state parameter being available to the filter. Since the estimate generated from the filter is aligned with the instance of the state parameter being measured. Thus, inputs from the different tracking systems having different measurement delays are aligned in timing of the estimates generated from and thus reducing the errors for real-time tracking.

Angular velocity calculated based on gyroscope measurements can be used to determine the rotation of a sensor module about a vertical axis. Such a rotation can be dependent on the initial orientation estimation, such as an estimate performed at a time of activation of the sensor module for use. For example, the initial estimate can be at a time of switching the sensor module on while the sensor module is in an assumed calibration position. The dependency on the initial estimation can cause the increased accumulation of the drift error over time. To reduce such error accumulation the rotation angle about the vertical axis received from the sensor module can be corrected using rotation/orientation measurements received from the optical-based tracking system. Preferably, the optical-tracking system provides the rotation quaternion in its own coordinate system (e.g., relative to stationary features of surroundings visible in images captured by the cameras, instead of relative to the head 107 of the user). Thus, the rotation angle received from the optical-tracking system does not depend on the current orientation or position of the camera (e.g., a camera configured in the head module 111).

When the sensor module leaves the field of view of the camera of the optical-based tracking system, the computing device 141 can continue using the measurements from the inertial-based tracking system to feed the filter to generate subsequent estimates of the position and orientation of the sensor module. When the measurements from the optical-based tracking system become unavailable, the filter may stop being corrected via the measurement results from the optical-based tracking system; and the drift errors from the inertial-based tracking system can accumulate. Without the measurements from the optical-based tracking system, alternative techniques can be used to limit, reduce, or re-calibrate the estimates controlled by the measurements from the inertial-based tracking system. For example, the technique of U.S. Pat. No. 11,009,964, issued on May 18, 2021 and entitled “Length Calibration for Computer Models of Users to Generate Inputs for Computer Systems,” can be used. When a correction is determined using such a technique, the correction vector can be applied as a new measurement in the filter to generate improve the estimates. Thus, the correction of the measurements from the inertial-based tracking system is not limited to the use of measurements from an optical-based tracking system. Deviations from constraints assumed relations of rigid parts on kinematic chains, or deviations from patterns of movements predicted via Artificial Neural Networks, etc., can also be introduced into the filter as new measurements to improve estimates generated by the filter.

To reduce the undesirable artifacts and uncomfortable sensations when the position and orientation estimates from the filter are used to control an AR/MR/VR/XR application, corrections from an optical-based tracking system, ANN predictions based on movement patterns, assumed relations in kinematic chains, etc., can be applied in increments over a few iterations of measurement inputs from the inertial-based tracking system. For example, to correct the current position of a sensor module based on a position measurement from an optical-based tracking system, an interpretation scheme (e.g., a spline interpolation) can be used to generate a predicted change of position based on a series of position measurements from the inertial-based tracking system and the position measurement from the optical-based tracking system. The interpolation scheme can be used to generate a series of smoothed input to the filter over a few iterations, instead of a single input of the position measurement from the optical-based tracking system. Optionally, as more position measurements from the inertial-based tracking system becomes available, the interpolation can be updated to be based on a number of inertial-based measurements before the optical-based measurement and another number of inertial-based measurements after the optical-based measurement. Thus, the outputs from the interpolation scheme can be used as pseudo measurement inputs influenced by the optical-based measurement; and the pseudo measurement inputs can be used as a replacement of the optical-based measurement. From another point view, the interpretation scheme can be used as a predictive model of position measurements generated based on a number of inertial-based measurements and an optical-based measurement; and the measurements of the predictive model is provided to the filter to update estimates.

Alternatively, the interpolation scheme can be applied to the output of the interpolation scheme. For example, after an optical-based measurement is applied to the filter to cause a significant change, the interpolation is applied to smooth the change. In some embodiments, an interpolation scheme is applied to smooth the input the filter, and applied to further smooth the output of the filter.

Optionally, the rate of change of the filter output is limited by a threshold. For example, when the two successive outputs from the filter over a time period has a rate of change above the threshold, the change is scaled down such that the scaled output is in the same direction as the change between the two successive outputs but limited to have a rate that is no more than the threshold.

In FIG. 1, the sensor modules 111, 113, 115, 117 and 119 communicate their movement measurements to the computing device 141, which computes or predicts the orientation of the parts of the user, which are modeled as rigid parts on kinematic changes, such as forearms 112 and 114, upper arms 103 and 105, hands 106 and 108, torso 101 and head 107.

The head module 111 can include one or more cameras to implement an optical-based tracking system to determine the positions and orientations of other sensor modules 113, 115, 117 and 119. Each of the sensor modules 111, 113, 115, 117 and 119 can have accelerometers and gyroscopes to implement an inertial-based tracking system for their positions and orientations.

In some implementations, each of the sensor modules 111, 113, 115, 117 and 119 communicates its measurements directly to the computing device 141 in a way independent from the operations of other sensor modules. Alternative, one of the sensor modules 111, 113, 115, 117 and 119 may function as a base unit that receives measurements from one or more other sensor modules and transmit the bundled and/or combined measurements to the computing device 141. In some implementations, the computing device 141 is implemented in a base unit, or a mobile computing device, and used to generate the predicted measurements for an AR/MR/VR/XR application.

Preferably, wireless connections made via a personal area wireless network (e.g., Bluetooth connections), or a local area wireless network (e.g., Wi-Fi connections) are used to facilitate the communication from the sensor modules 111, 113, 115, 117 and 119 to the computing device 141. Alternatively, wired connections can be used to facilitate the communication among some of the sensor modules 111, 113, 115, 117 and 119 and/or with the computing device 141.

For example, a hand module 117 or 119 attached to or held in a corresponding hand 106 or 108 of the user may receive the motion measurements of a corresponding arm module 115 or 113 and transmit the motion measurements of the corresponding hand 106 or 108 and the corresponding upper arm 105 or 103 to the computing device 141.

Optionally, the hand 106, the forearm 114, and the upper arm 105 can be considered a kinematic chain, for which an artificial neural network can be trained to predict the orientation measurements generated by an optical track system, based on the sensor inputs from the sensor modules 117 and 115 that are attached to the hand 106 and the upper arm 105, without a corresponding device on the forearm 114.

Optionally or in combination, the hand module (e.g., 117) may combine its measurements with the measurements of the corresponding arm module 115 to compute the orientation of the forearm connected between the hand 106 and the upper arm 105, in a way as disclosed in U.S. Pat. No. 10,379,613, issued Aug. 13, 2019 and entitled “Tracking Arm Movements to Generate Inputs for Computer Systems”, the entire disclosure of which is hereby incorporated herein by reference.

For example, the hand modules 117 and 119 and the arm modules 115 and 113 can be each respectively implemented via a base unit (or a game controller) and an arm/shoulder module discussed in U.S. Pat. No. 10,509,469, issued Dec. 17, 2019 and entitled “Devices for Controlling Computers based on Motions and Positions of Hands”, the entire disclosure of which application is hereby incorporated herein by reference.

In some implementations, the head module 111 is configured as a base unit that receives the motion measurements from the hand modules 117 and 119 and the arm modules 115 and 113 and bundles the measurement data for transmission to the computing device 141. In some instances, the computing device 141 is implemented as part of the head module 111. The head module 111 may further determine the orientation of the torso 101 from the orientation of the arm modules 115 and 113 and/or the orientation of the head module 111, using an artificial neural network trained for a corresponding kinematic chain, which includes the upper arms 103 and 105, the torso 101, and/or the head 107.

For the determination of the orientation of the torso 101, the hand modules 117 and 119 are optional in the system illustrated in FIG. 1.

Further, in some instances the head module 111 is not used in the tracking of the orientation of the torso 101 of the user.

Typically, the measurements of the sensor modules 111, 113, 115, 117 and 119 are calibrated for alignment with a common reference system, such as a reference system 100.

After the calibration, the hands 106 and 108, the arms 103 and 105, the head 107, and the torso 101 of the user may move relative to each other and relative to the reference system 100. The measurements of the sensor modules 111, 113, 115, 117 and 119 provide orientations of the hands 106 and 108, the upper arms 105, 103, and the head 107 of the user relative to the reference system 100. The computing device 141 computes, estimates, or predicts the current orientation of the torso 101 and/or the forearms 112 and 114 from the current orientations of the upper arms 105, 103, the current orientation the head 107 of the user, and/or the current orientation of the hands 106 and 108 of the user and their orientation history using the prediction model 116.

Optionally or in combination, the computing device 141 may further compute the orientations of the forearms from the orientations of the hands 106 and 108 and upper arms 105 and 103, e.g., using a technique disclosed in U.S. Pat. No. 10,379,613, issued Aug. 13, 2019 and entitled “Tracking Arm Movements to Generate Inputs for Computer Systems”, the entire disclosure of which is hereby incorporated herein by reference.

FIG. 2 illustrates a system to control computer operations according to one embodiment. For example, the system of FIG. 2 can be implemented via attaching the arm modules 115 and 113 to the upper arms 105 and 103 respectively, the head module 111 to the head 107 and/or hand modules 117 and 119, in a way illustrated in FIG. 1.

In FIG. 2, the head module 111 and the arm module 113 have micro-electromechanical system (MEMS) inertial measurement units 121 and 131 that measure motion parameters and determine orientations of the head 107 and the upper arm 103.

Similarly, the hand modules 117 and 119 can also have inertial measurement units (IMUs). In some applications, the hand modules 117 and 119 measure the orientation of the hands 106 and 108 and the movements of fingers are not separately tracked. In other applications, the hand modules 117 and 119 have separate IMUs for the measurement of the orientations of the palms of the hands 106 and 108, as well as the orientations of at least some phalange bones of at least some fingers on the hands 106 and 108. Examples of hand modules can be found in U.S. Pat. No. 10,534,431, issued filed Jan. 14, 2020 and entitled “Tracking Finger Movements to Generate Inputs for Computer Systems,” the entire disclosure of which is hereby incorporated herein by reference.

Each of the Inertial Measurement Unit 131 and 121 has a collection of sensor components that enable the determination of the movement, position and/or orientation of the respective IMU along a number of axes. Examples of the components are: a MEMS accelerometer that measures the projection of acceleration (the difference between the true acceleration of an object and the gravitational acceleration); a MEMS gyroscope that measures angular velocities; and a magnetometer that measures the magnitude and direction of a magnetic field at a certain point in space. In some embodiments, the IMUs use a combination of sensors in three and two axes (e.g., without a magnetometer).

The computing device 141 has a prediction model 116 and a motion processor 145. The measurements of the Inertial Measurement Units (e.g., 131, 121) from the head module 111, arm modules (e.g., 113 and 115), and/or hand modules (e.g., 117 and 119) are used in the prediction model 116 to generate predicted measurements of at least some of the parts that do not have attached sensor modules, such as the torso 101, and forearms 112 and 114. The predicted measurements and/or the measurements of the Inertial Measurement Units (e.g., 131, 121) are used in the motion processor 145.

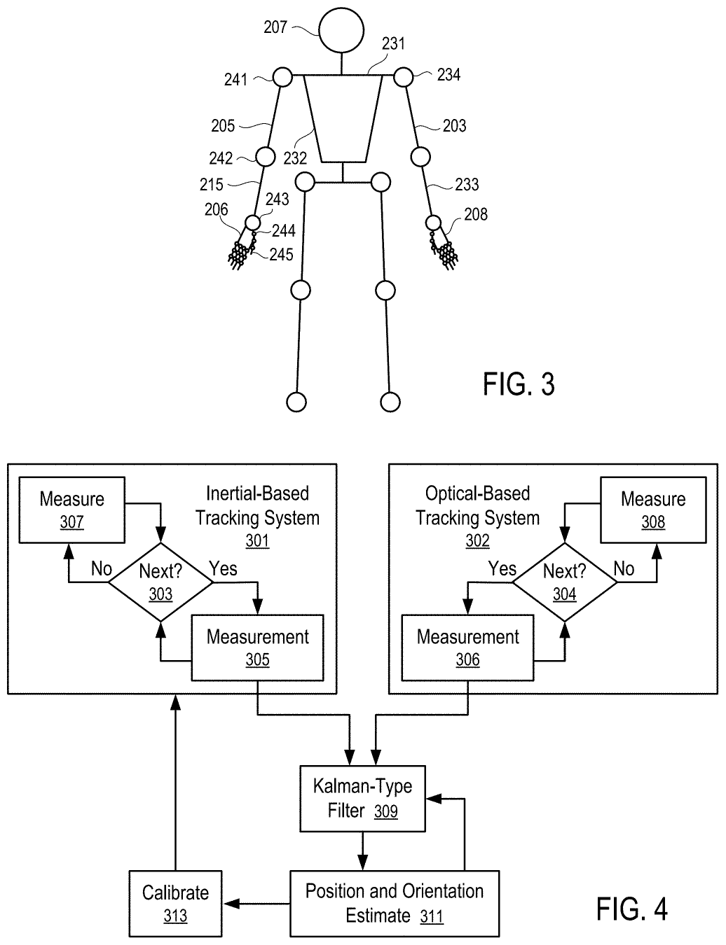

The motion processor 145 has a skeleton model 143 of the user (e.g., illustrated FIG. 3). The motion processor 145 controls the movements of the parts of the skeleton model 143 according to the movements/orientations of the corresponding parts of the user. For example, the orientations of the hands 106 and 108, the forearms 112 and 114, the upper arms 103 and 105, the torso 101, the head 107, as measured by the IMUs of the hand modules 117 and 119, the arm modules 113 and 115, the head module 111 sensor modules and/or predicted by the prediction model 116 based on the IMU measurements are used to set the orientations of the corresponding parts of the skeleton model 143.

Since the torso 101 does not have a separately attached sensor module, the movements/orientation of the torso 101 is predicted using the prediction model 116 using the sensor measurements from sensor modules on a kinematic chain that includes the torso 101. For example, the prediction model 116 can be trained with the motion pattern of a kinematic chain that includes the head 107, the torso 101, and the upper arms 103 and 105 and can be used to predict the orientation of the torso 101 based on the motion history of the head 107, the torso 101, and the upper arms 103 and 105 and the current orientations of the head 107, and the upper arms 103 and 105.

Similarly, since a forearm 112 or 114 does not have a separately attached sensor module, the movements/orientation of the forearm 112 or 114 is predicted using the prediction model 116 using the sensor measurements from sensor modules on a kinematic chain that includes the forearm 112 or 114. For example, the prediction model 116 can be trained with the motion pattern of a kinematic chain that includes the hand 106, the forearm 114, and the upper arm 105 and can be used to predict the orientation of the forearm 114 based on the motion history of the hand 106, the forearm 114, the upper arm 105 and the current orientations of the hand 106, and the upper arm 105.

The skeleton model 143 is controlled by the motion processor 145 to generate inputs for an application 147 running in the computing device 141. For example, the skeleton model 143 can be used to control the movement of an avatar/model of the arms 112, 114, 105 and 103, the hands 106 and 108, the head 107, and the torso 101 of the user of the computing device 141 in a video game, a virtual reality, a mixed reality, or augmented reality, etc.

Preferably, the arm module 113 has a microcontroller 139 to process the sensor signals from the IMU 131 of the arm module 113 and a communication module 133 to transmit the motion/orientation parameters of the arm module 113 to the computing device 141. Similarly, the head module 111 has a microcontroller 129 to process the sensor signals from the IMU 121 of the head module 111 and a communication module 123 to transmit the motion/orientation parameters of the head module 111 to the computing device 141.

Optionally, the arm module 113 and the head module 111 have LED indicators 137 respectively to indicate the operating status of the modules 113 and 111.

Optionally, the arm module 113 has a haptic actuator 138 respectively to provide haptic feedback to the user.

Optionally, the head module 111 has a display device 127 and/or buttons and other input devices 125, such as a touch sensor, a microphone, a camera, etc.

In some implementations, the head module 111 is replaced with a module that is similar to the arm module 113 and that is attached to the head 107 via a strap or is secured to a head mount display device.

In some applications, the hand module 119 can be implemented with a module that is similar to the arm module 113 and attached to the hand via holding or via a strap. Optionally, the hand module 119 has buttons and other input devices, such as a touch sensor, a joystick, etc.

For example, the handheld modules disclosed in U.S. Pat. No. 10,534,431, issued Jan. 14, 2020 and entitled “Tracking Finger Movements to Generate Inputs for Computer Systems”, U.S. Pat. No. 10,379,613, issued Aug. 13, 2019 and entitled “Tracking Arm Movements to Generate Inputs for Computer Systems”, and/or U.S. Pat. No. 10,509,469, issued Dec. 17, 2019 and entitled “Devices for Controlling Computers based on Motions and Positions of Hands” can be used to implement the hand modules 117 and 119, the entire disclosures of which applications are hereby incorporated herein by reference.

When a hand module (e.g., 117 or 119) tracks the orientations of the palm and a selected set of phalange bones, the motion pattern of a kinematic chain of the hand captured in the prediction model 116 can be used in the prediction model 116 to predict the orientations of other phalange bones that do not wear sensor modules.

FIG. 2 shows a hand module 119 and an arm module 113 as examples. In general, an application for the tracking of the orientation of the torso 101 typically uses two arm modules 113 and 115 as illustrated in FIG. 1. The head module 111 can be used optionally to further improve the tracking of the orientation of the torso 101. Hand modules 117 and 119 can be further used to provide additional inputs and/or for the prediction/calculation of the orientations of the forearms 112 and 114 of the user.

Typically, an Inertial Measurement Unit (e.g., 131 or 121) in a module (e.g., 113 or 111) generates acceleration data from accelerometers, angular velocity data from gyrometers/gyroscopes, and/or orientation data from magnetometers. The microcontrollers 139 and 129 perform preprocessing tasks, such as filtering the sensor data (e.g., blocking sensors that are not used in a specific application), applying calibration data (e.g., to correct the average accumulated error computed by the computing device 141), transforming motion/position/orientation data in three axes into a quaternion, and packaging the preprocessed results into data packets (e.g., using a data compression technique) for transmitting to the host computing device 141 with a reduced bandwidth requirement and/or communication time.

Each of the microcontrollers 129, 139 may include a memory storing instructions controlling the operations of the respective microcontroller 129 or 139 to perform primary processing of the sensor data from the IMU 121, 131 and control the operations of the communication module 123, 133, and/or other components, such as the LED indicator 137, the haptic actuator 138, buttons and other input devices 125, the display device 127, etc.

The computing device 141 may include one or more microprocessors and a memory storing instructions to implement the motion processor 145. The motion processor 145 may also be implemented via hardware, such as Application-Specific Integrated Circuit (ASIC) or Field-Programmable Gate Array (FPGA).

In some instances, one of the modules 111, 113, 115, 117, and/or 119 is configured as a primary input device; and the other module is configured as a secondary input device that is connected to the computing device 141 via the primary input device. A secondary input device may use the microprocessor of its connected primary input device to perform some of the preprocessing tasks. A module that communicates directly to the computing device 141 is consider a primary input device, even when the module does not have a secondary input device that is connected to the computing device via the primary input device.

In some instances, the computing device 141 specifies the types of input data requested, and the conditions and/or frequency of the input data; and the modules 111, 113, 115, 117, and/or 119 report the requested input data under the conditions and/or according to the frequency specified by the computing device 141. Different reporting frequencies can be specified for different types of input data (e.g., accelerometer measurements, gyroscope/gyrometer measurements, magnetometer measurements, position, orientation, velocity).

In general, the computing device 141 may be a data processing system, such as a mobile phone, a desktop computer, a laptop computer, a head mount virtual reality display, a personal medial player, a tablet computer, etc.

FIG. 3 illustrates a skeleton model that can be controlled by tracking user movements according to one embodiment. For example, the skeleton model of FIG. 3 can be used in the motion processor 145 of FIG. 2.

The skeleton model illustrated in FIG. 3 includes a torso 232 and left and right upper arms 203 and 205 that can move relative to the torso 232 via the shoulder joints 234 and 241. The skeleton model may further include the forearms 215 and 233, hands 206 and 208, neck, head 207, legs and feet. In some instances, a hand 206 includes a palm connected to phalange bones (e.g., 245) of fingers, and metacarpal bones of thumbs via joints (e.g., 244).

The positions/orientations of the rigid parts of the skeleton model illustrated in FIG. 3 are controlled by the measured orientations of the corresponding parts of the user illustrated in FIG. 1. For example, the orientation of the head 207 of the skeleton model is configured according to the orientation of the head 107 of the user as measured using the head module 111; the orientation of the upper arm 205 of the skeleton model is configured according to the orientation of the upper arm 105 of the user as measured using the arm module 115; and the orientation of the hand 206 of the skeleton model is configured according to the orientation of the hand 106 of the user as measured using the hand module 117; etc.

The prediction model 116 can have multiple artificial neural networks trained for different motion patterns of different kinematic chains.

For example, a clavicle kinematic chain can include the upper arms 203 and 205, the torso 232 represented by the clavicle 231, and optionally the head 207, connected by shoulder joints 241 and 234 and the neck. The clavicle kinematic chain can be used to predict the orientation of the torso 232 based on the motion history of the clavicle kinematic chain and the current orientations of the upper arms 203 and 205, and the head 207.

For example, a forearm kinematic chain can include the upper arm 205, the forearm 215, and the hand 206 connected by the elbow joint 242 and the wrist joint 243. The forearm kinematic chain can be used to predict the orientation of the forearm 215 based on the motion history of the forearm kinematic chain and the current orientations of the upper arm 205, and the hand 206.

For example, a hand kinematic chain can include the palm of the hand 206, phalange bones 245 of fingers on the hand 206, and metacarpal bones of the thumb on the hand 206 connected by joints in the hand 206. The hand kinematic chain can be used to predict the orientation of the phalange bones and metacarpal bones based on the motion history of the hand kinematic chain and the current orientations of the palm, and a subset of the phalange bones and metacarpal bones tracked using IMUs in a hand module (e.g., 117 or 119).

For example, a torso kinematic chain may include clavicle kinematic chain and further include forearms and/or hands and legs. For example, a leg kinematic chain may include a foot, a lower leg, and an upper leg.

An artificial neural network of the prediction model 116 can be trained using a supervised machine learning technique to predict the orientation of a part in a kinematic chain based on the orientations of other parts in the kinematic chain such that the part having the predicted orientation does not have to wear a separate sensor module to track its orientation.

Further, an artificial neural network of the prediction model 116 can be trained using a supervised machine learning technique to predict the orientations of parts in a kinematic chain that can be measured using one tracking technique based on the orientations of parts in the kinematic chain that are measured using another tracking technique.

For example, the tracking system as illustrated in FIG. 2 measures the orientations of the modules 111, 113, . . . , 119 using Inertial Measurement Units (e.g., 121, 131, . . . ). The inertial-based sensors offer good user experiences, have less restrictions on the use of the sensors, and can be implemented in a computational efficient way. However, the inertial-based sensors may be less accurate than certain tracking methods in some situations, and can have drift errors and/or accumulated errors through time integration.

For example, an optical tracking system can use one or more cameras to track the positions and/or orientations of optical markers that are in the fields of view of the cameras. When the optical markers are within the fields of view of the cameras, the images captured by the cameras can be used to compute the positions and/or orientations of optical markers and thus the orientations of parts that are marked using the optical markers. However, the optical tracking system may not be as user friendly as the inertial-based tracking system and can be more expensive to deploy. Further, when an optical marker is out of the fields of view of cameras, the positions and/or orientations of optical marker cannot be determined by the optical tracking system.

An artificial neural network of the prediction model 116 can be trained to predict the measurements produced by the optical tracking system based on the measurements produced by the inertial-based tracking system. Thus, the drift errors and/or accumulated errors in inertial-based measurements can be reduced and/or suppressed, which reduces the need for re-calibration of the inertial-based tracking system.

FIG. 4 shows a technique to combine measurements from an optical-based tracking system and an inertial-based tracking system to determine the positions and orientations of parts of a user according to one embodiment.

For example, the technique of FIG. 4 can be implemented in the system of FIG. 1 using the sensor modules illustrated in FIG. 2 to control a skeleton model of FIG. 3 in an AR/VR/MR/XR application.

In FIG. 4, an inertial-based tracking system 301 and an optical-based tracking system 302 are configured to track, determine, or measure the position and orientation of a senor module, such as an arm module 113 or a hand module 119.

For example, after the calibration operation to determine an initial position and orientation of the sensor module, the inertial-based tracking system 301 can measure 307 subsequent positions and orientations of the sensor module (e.g., at the rate of hundreds per second), independent of measurements generated by the optical-based tracking system 302.

Similarly, when the sensor module is within the field of view of its camera set, the optical-based tracking system can measure 308 positions and orientations of the sensor module at a sequence of time instances (e.g., at the rate of 30 to 60 per second), independent of measurements generated by the inertial-based tracking system 301.

Once a measurement 305 of position and orientation is determined at block 303 to be available in the inertial-based tracking system 301, the measurement 305 is provided to a Kalman-type filter 309 to update its position and orientation estimate 311 for the sensor module. The estimate 311 identifies the real-time position and orientation of the sensor module, in view of the measurement 305 from the inertial-based tracking system.

Similarly, once a measurement 306 of position and orientation is determined at block 304 to be available in the optical-based tracking system 302, the measurement 306 is provided to the Kalman-type filter 309 to update its position and orientation estimate 311 for the sensor module. The estimate 311 identifies the real-time position and orientation of the sensor module, in view of the measurement 305 from the inertial-based tracking system.

The Kalman-type filter 309 is configured to generate a new estimate based on a prior estimate and a new measurement (e.g., 305 or 306). The Kalman-type filter 309 includes estimates for state parameters (e.g., position and orientation) and rates of the state parameters (e.g., velocity). A filter parameter α provides a weight for a change from the prior estimate of the state parameters to the new measurements of the state parameters for adding to the prior estimate of the state parameters.

In some embodiments, the rates of the state parameters are computed from new measurements (e.g., 305 or 306) and their prior estimates; and a filter parameter β provides a weight for the computed rates for adding to the prior estimates of the rates.

Thus, based on the position and orientation measurements of the sensor module, measured by the inertial-based tracking system and the optical-based tracking system separately, the Kalman-type filter 309 generates estimate not only for the position and orientation of the sensor module, but also a changing rate of the position and/or orientation of the sensor module. The estimates of the Kalman-type filter 309 is based on not only the position measurements, but also the orientation measurements. In some implementations, the inputs to the Kalman-type filter 309 also includes angular velocity of the sensor module measured by the inertial-based tracking system. Further, the estimates of the Kalman-type filter 309 can include estimates of the bias of accelerometer and the bias of gyroscope in the sensor module.

Periodically, the estimate 311 as improved via the measurements 306 from the optical-based tracking system 302 is used to calibrate 313 the inertial-based tracking system 301 and thus remove or reduce the accumulated drift errors in the inertial-based tracking system 301. The timing to perform the calibration 313 can be triggered by the availability of the measurements 306 from the optical-based tracking system 302. For example, after a threshold number of measurements 306 from the optical-based tracking system 302 are used to update the estimates of the Kalman-type filter 309 at regular time interval (e.g., at the rate of 30 to 60 per second), the influence of the errors in the prior estimates can be considered have diminished; and the current position and orientation estimate 311 can be used to calibrate the inertial-based tracking system 301.

In some embodiments, the estimates of the bias of accelerometer and the bias of gyroscope in the sensor module can be generated by the Kalman-type filter 309. When the estimated biases are high (e.g., above certain threshold values), the measurements from the optical-based tracking system 302 can be used to calibrate the inertial-based tracking system 301 directly. Thus, the frequency of the calibration of the inertial-based tracking system can be reduced.

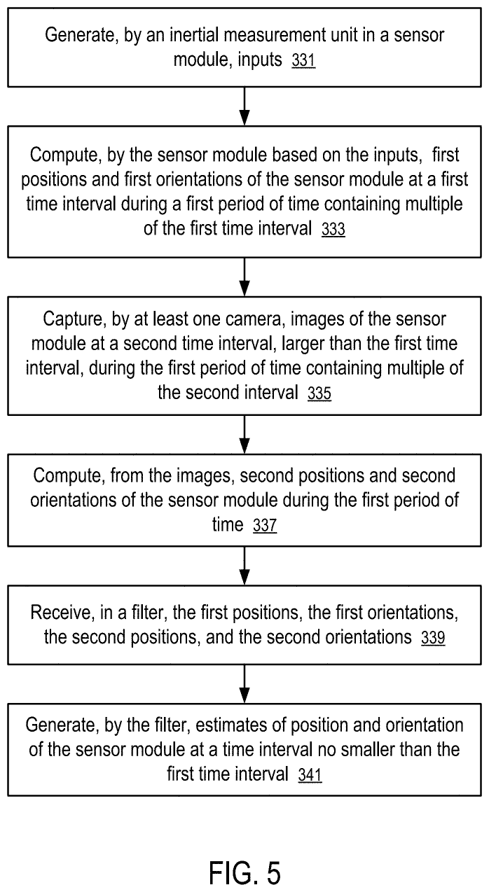

FIG. 5 shows a method to generate real-time estimates of positions and orientations of a sensor module according to one embodiment.

For example, the method of FIG. 5 can be implemented in the system of FIG. 1, using sensor modules illustrated in FIG. 2 to control a skeleton model of FIG. 3 in an AR/XR/MR/VR application, using the technique of FIG. 4.

At block 331, an inertial measurement unit (e.g., 131) in a sensor module (e.g., 113) generates inputs.

For example, the inertial measurement unit (e.g., 131) can include a micro-electromechanical system (MEMS) gyroscope, a MEMS accelerometer, and a MEMS magnetometer. The inputs generated by the inertial measurement unit (e.g., 131) include the acceleration of the sensor module (e.g., 113), the rotation of the sensor module (e.g., 113), and the direction of the gravity vector.

At block 333, the sensor module (e.g., 113) computes, based on the inputs from the inertial measurement unit (e.g., 131), first positions and first orientations of the sensor module (e.g., 113) at a first time interval during a first period of time containing multiple of the first time interval (e.g., at a rate of hundreds per second).

For example, based on an initial position, velocity, orientation of the sensor module (e.g., 113), the inputs of the acceleration, rotation and gravity vector of the inertial measurement unit (e.g., 131) over the first period of time can be integrated over time (e.g., using a Runge-Kutta method, or another integration technique) to obtain the position, velocity, orientation of the sensor module (e.g., 113) during the first period of time at the first time interval.

At block 335, at least one camera is used to capture images of the sensor module (e.g., 113) at a second time interval, larger than the first time interval, during the first period of time containing multiple of the second interval (e.g., at a rate of 30 to 60 per second).

For example, the at least one camera can be configured to provide a stereoscopic computer vision to facilitate the measurement of the position and orientation of the sensor module (e.g., 113) from the images.

For example, the at least one camera can be configured in a head mount display, such as a display device 127 in a head module 111.

At block 337, a computing device (e.g., 141) computes, from the images, second positions and second orientations of the sensor module during the first period of time.

For example, the computing device (e.g., 141) can be a mobile computing device, such as a mobile phone, a tablet computer, a notebook computer, a personal media player, a set top box, etc. Alternatively, the computing device (e.g., 141) can be a personal computer, a television set, or a sensor module (e.g., 111) that functions as a base unit.

At block 339, a filter (e.g., 309) receives the first positions, the first orientations, the second positions, and the second orientations.

At block 341, the filter (e.g., 309) estimates of positions and orientations of the sensor module at a time interval no smaller than the first time interval.

For example, the filter (e.g., 309) can be a Kalman-type filter 309.

For example, the filter (e.g., 309) has a set of state parameters, including first parameters (e.g., position and orientation) and at least one second parameter (e.g., velocity) that is a rate of at least one of the first parameters (e.g., position). The filter (e.g., 309) is configured to combine a prior estimate of the set of state parameters with a measurement of the first parameters (e.g., position and orientation) to generate a subsequent estimate of the set of state parameters.

At an instance to update the prior estimate of the set of state parameters, the measurement of the first parameters used in the filter (e.g., 309) can be generated by either the sensor module (e.g., 113) based on inputs from the inertial measurement unit (e.g., 131), or the computing device (e.g., 141) from the images captured by the at least one camera.

For example, a filter parameter α can be used to weight on a difference between the prior estimate of the first parameters and the measurement of the first parameters for adding to the prior estimate in generating the subsequent estimate of the first parameters. Another filter parameter β can be used to weight on the second parameter as computed from the prior estimate of the first parameters and the measurement of the first parameters, for adding to the prior estimate of the second parameter to generate the subsequent estimate of the second parameter.

In some implementations, the filter (e.g., 309) is further configured to receive an angular velocity measurement of the sensor module to generate the subsequent estimate.

In some implementations, the filter (e.g., 309) is configured to generate an estimate of a bias of the micro-electromechanical system gyroscope and an estimate of a bias of the micro-electromechanical system accelerometer.

When the sensor module (e.g., 113) is moved outside of the field of view of the at least one camera, the computing device (e.g., 141) can further generate estimates of the state parameters at the first time interval based on position and orientation inputs from the sensor module (e.g., 113).

In response to the sensor module moving back into the field of view of the at least one camera, the computing device (e.g., 141) can limit a change in estimates of the filter in response to a first input of position and orientation generated based on the at least one camera.

For example, the maximum rate of changes in the first parameters (e.g., position and orientation) can be observed and determined during the operation where position and orientation measurements are available based on inputs from the inertial measurement unit (e.g., 131) and inputs from the at least one camera. The maximum rate can be used as a threshold to limit the change when the sensor module moves outside of and then back into the field of view of the at least one camera.

Alternatively, or in combination, the computing device is configured to limit the change by applying an input to the filter based on an interpolation of multiple inputs of position and orientation from the sensor module and the first input of position and orientation generated based on the at least camera, when the sensor module re-enters the field of view of the at least one camera.

Optionally, the computing device (e.g., 141) is configured determine a correction to a position or an orientation of the sensor module (e.g., 113) determined using the inertial measurement unit (e.g., 131), based on an assumed motion relation or a prediction using an artificial neural network according to a pattern of motion. The computing device (e.g., 141) then applies the correction through the filter (e.g., 309). For example, the correction can be used to compute a corrected position and orientation of the sensor module; and the corrected position and orientation can be used as a measurement input to the filter (e.g., 309) to generate a subsequent estimate.

The filter (e.g., 309) can be implemented as instructions executed by a microprocessor in the computing device (e.g., 141), or a logic circuit.

The present disclosure includes methods and apparatuses which perform these methods, including data processing systems which perform these methods, and computer readable media containing instructions which when executed on data processing systems cause the systems to perform these methods.

For example, the computing device 141, the arm modules 113, 115 and/or the head module 111 can be implemented using one or more data processing systems.

A typical data processing system may include includes an inter-connect (e.g., bus and system core logic), which interconnects a microprocessor(s) and memory. The microprocessor is typically coupled to cache memory.

The inter-connect interconnects the microprocessor(s) and the memory together and also interconnects them to input/output (I/O) device(s) via I/O controller(s). I/O devices may include a display device and/or peripheral devices, such as mice, keyboards, modems, network interfaces, printers, scanners, video cameras and other devices known in the art. In one embodiment, when the data processing system is a server system, some of the I/O devices, such as printers, scanners, mice, and/or keyboards, are optional.

The inter-connect can include one or more buses connected to one another through various bridges, controllers and/or adapters. In one embodiment the I/O controllers include a USB (Universal Serial Bus) adapter for controlling USB peripherals, and/or an IEEE-1394 bus adapter for controlling IEEE-1394 peripherals.

The memory may include one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In the present disclosure, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to non-transitory, recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROM), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system, comprising:
a sensor module having an inertial measurement unit and a microcontroller configured to generate, based on inputs from the inertial measurement unit, first positions and first orientations of the sensor module at a first time interval during a first period of time containing multiple of the first time interval;
at least one camera configured to capture, when the sensor module is within a field of view of the at least one camera, images of the sensor module at a second time interval, larger than the first time interval, during the first period of time containing multiple of the second interval;
a computing device configured to compute, from the images, second positions and second orientations of the sensor module during the first period of time; and
a filter configured to receive the first positions, the first orientations, the second positions, and the second orientations to generate estimates of positions and orientations of the sensor module at a time interval no smaller than the first time interval.

2. The system of claim 1, wherein the filter is a Kalman-type filter.

3. The system of claim 1, wherein the filter is configured to combine a prior estimate of a set of state parameters, having first parameters and at least one second parameter that is a rate of at least one of the first parameters, with a measurement of the first parameters to generate a subsequent estimate of the set of state parameters.

4. The system of claim 3, wherein the measurement of the first parameters is generated by either the sensor module based on inputs from the inertial measurement unit or the computing device from the images captured by the at least one camera.

5. The system of claim 4, wherein the first parameters include an orientation of the sensor module.

6. The system of claim 5, wherein the filter is further configured to receive an angular velocity measurement of the sensor module to generate the subsequent estimate.

7. The system of claim 6, wherein the at least one camera is configured in a head mounted display; and the computing device is a mobile computing device.

8. The system of claim 5, wherein when the sensor module is moved outside of the field of view of the at least one camera, the computing device is configured to further generate estimates at the first time interval based on position and orientation inputs from the sensor module.

9. The system of claim 8, wherein in response to the sensor module moving back into the field of view of the at least one camera, the computing device is configured to limit a change in estimates of the filter in response to a first input of position and orientation generated based on the at least one camera.

10. The system of claim 9, wherein the computing device is configured to limit the change by applying an input to the filter based on an interpolation of multiple inputs of position and orientation from the sensor module and the first input of position and orientation generated based on the at least camera.

11. The system of claim 9, wherein the computing device is configured to limit the change based on a maximum change in a rate of changing from one estimate to a next estimate during a second period of time in which the sensor module is in the field of view of the at least one camera.

12. The system of claim 5, wherein the inertial measurement unit includes a micro-electromechanical system gyroscope and a micro-electromechanical system accelerometer; and the filter is configured to generate an estimate of a bias of the micro-electromechanical system gyroscope and an estimate of a bias of the micro-electromechanical system accelerometer.

13. The system of claim 5, wherein the computing device is configured determine a correction to a position or an orientation of the sensor module determined using the inertial measurement unit, based on an assumed motion relation or a prediction using an artificial neural network according to a pattern of motion, and apply the correction through the filter.

14. A method, comprising:
computing, by a sensor module having an inertial measurement unit and based on inputs from the inertial measurement unit, first positions and first orientations of the sensor module at a first time interval during a first period of time containing multiple of the first time interval;
capturing, by at least one camera, images of the sensor module at a second time interval, larger than the first time interval, during the first period of time containing multiple of the second interval;
computing, from the images, second positions and second orientations of the sensor module during the first period of time;
receiving, in a filter, the first positions, the first orientations, the second positions, and the second orientations; and
generating, by the filter, estimates of positions and orientations of the sensor module at a time interval no smaller than the first time interval.

15. The method of claim 14, wherein the generating of the estimates includes combining a prior estimate of a set of state parameters, having first parameters and at least one second parameter that is a rate of at least one of the first parameters, with a measurement of the first parameters to generate a subsequent estimate of the set of state parameters.

16. The method of claim 15, wherein the set of state parameters include a position of the sensor module, an orientation of the sensor module, and a velocity of the sensor module.

17. The method of claim 16, wherein the set of state parameters further include a bias of an accelerometer in the inertial measurement unit and a bias of a gyroscope in the inertial measurement unit.

18. The method of claim 17, further comprising:
limiting a rate of a change from a first estimate of the filter to a second estimate of the filter based on a threshold.

19. A non-transitory computer storage medium storing instructions which when executed on a computing device, causes the computing device to perform a method, comprising:
receiving, from a sensor module having an inertial measurement unit and based on inputs from the inertial measurement unit, first positions and first orientations of the sensor module at a first time interval during a first period of time containing multiple of the first time interval;
receiving, from at least one camera, images of the sensor module at a second time interval, larger than the first time interval, during the first period of time containing multiple of the second interval;
computing, from the images, second positions and second orientations of the sensor module during the first period of time;
applying the first positions, the first orientations, the second positions, and the second orientations to a filter to generate estimates of positions and orientations of the sensor module at a time interval no smaller than the first time interval.

20. The non-transitory computer storage medium of claim 19, wherein the filter is a Kalman-type filter; and state parameters of the Kalman-type filter includes a position of the sensor module, an orientation of the sensor module, a velocity of the sensor module, a bias of an accelerometer of the inertial measurement unit, and a bias of a gyroscope of the inertial measurement unit.
